(19) United States
(12) Patent Application Publication
(10) Pub. No.: US 2025/0166887 A1
(43) Pub. Date: May 22, 2025

(54) RF High Power Transformer Wound with Twisted Wire Bundle

(71) Applicant: WJLP COMPANY INC., Stockton, CA (US)

(72) Inventor: Weyman John Lundquist, Berkeley, CA (US)

(21) Appl. No.: 18/952,006

(22) Filed: Nov. 19, 2024

Related U.S. Application Data
(60) Provisional application No. 63/601,015, filed on Nov. 20, 2023.

(51) Int. Cl. H01F 30/16; H01F 1/34; H01F 1/37; H01F 27/255; H01F 27/32; H01F 41/066; H01F 41/069

(52) U.S. Cl. CPC H01F 30/16; H01F 1/344; H01F 1/37; H01F 27/255; H01F 27/324; H01F 41/066; H01F 41/069

(57) ABSTRACT

A transformer is formed of a twisted-wire bundle wound as a single layer with wires of the bundle comprising wires insulated with extruded plastic insulation at least 0.001 inch thick. A magnetic material is disposed within the transformer with at least a portion within the coil having either solenoid or toroid shape. In embodiments, the transformer is formed by twisting wires into a twisted wire bundle; winding the twisted wire bundle into a single-layer coil; placing the single-layer coil into a form; injecting a powdered magnetic material suspended in a polymer into the coil; curing, or hardening, the polymer; and connecting wires of the twisted wire bundle to form transformer windings.

### CROSS-REFERENCE TO RELATED APPLICATIONS

This application claims priority to Provisional Application No. 63/601,015 filed Nov. 20, 2023, the entirety of which is incorporated by reference.

### BACKGROUND

RF Transformers are unique in requiring a primary winding with very high self-resonant frequency and very tight coupling between the input and output windings. They also require techniques and materials to manage the winding and core losses that result from the high frequency energy, and they should be easy to manufacture. High power transformers also typically operate at high voltage levels, so high levels of interwinding isolation are required for safety and reliability.

U.S. Pat. No. 11,049,649 describes a very high frequency wideband signal transformer that has winding consisting of 6 strands of enameled magnet wire twisted around a non-magnetic cylindrical tube. This winding is then passed through the two holes of a core commonly referred to as a balun. The individual strands of the six strand winding are then connected according in a specified arrangement according to two (or three) schematic representations.

The transformer of '649 has many limitations. The core must be wound by hand because there is no automatic winding equipment to wind balun cores. The winding is not suitable for power applications due to the fine gauge of the wire and small size of the core. There is very little isolation between the primary and secondary windings of the transformer due to the low dielectric strength of the magnet wire insulation. The core materials for use in the balun core are limited to the standard materials available on the market. Specialized equipment is needed to wrap the six strand winding around the non-magnetic bundle core, and space is wasted because this type of winding has an increase diameter due to the non-magnetic bundle core.

Some studies have been performed of magnetic properties of powdered magnetic material suspended in polymer materials that can be cured into solids, and it has been proposed that such materials can be used to make preformed cores for transformers.

### SUMMARY

In an embodiment, a transformer is formed of a twisted-wire bundle wound as a single layer with wires of the bundle comprising wires insulated with extruded plastic insulation at least 0.001 inch thick. A magnetic material is disposed within the transformer with at least a portion within the coil having either solenoid or toroid shape. In embodiments, at least part of the magnetic material disposed within the transformer includes a powdered magnetic material suspended within a polymer, the polymer being cured or hardened after injection into the coil and transformer.

In embodiments, a transformer is formed by twisting wires into a twisted wire bundle; winding the twisted wire bundle into a single-layer coil; placing the single-layer coil into a form; injecting a powdered magnetic material suspended in a polymer into the coil; curing, or hardening, the polymer; and connecting wires of the twisted wire bundle to form transformer windings.

### BRIEF DESCRIPTION OF THE FIGURES

FIG. 1 is an illustration of a twisted wire bundle such as may be used for winding bundle-wound coils and transformers.

FIG. 2A is a perspective view of a bundle-wound transformer with solenoid-wound coil positioned within a preformed pot core, narrow E-E core, or narrow E-I core, in embodiments.

FIG. 2B is a cross section of a bundle-wound transformer of FIG. 2A.

FIG. 2C is an illustration of a toroidal transformer wound with a twisted wire bundle, in embodiments.

FIG. 3 is a schematic diagram illustrating a 6-strand twisted wire bundle-wound transformer coupled as a 1:1 turns-ratio transformer, in embodiments.

FIG. 4 is a schematic diagram illustrating a 6-strand twisted wire bundle-wound transformer coupled as a 1:2 turns-ratio transformer, in embodiments.

FIG. 5A is a schematic diagram illustrating a 6-strand twisted wire bundle-wound transformer coupled as a 2:1 turns ratio transformer, in embodiments.

FIG. 5B is a schematic diagram illustrating a 6-strand twisted wire bundle-wound transformer coupled as a 1:3 turns ratio transformer, in embodiments.

FIG. 5C is a schematic diagram illustrating a 6-strand twisted wire bundle-wound transformer coupled as a 3:1 turns ratio transformer, in embodiments.

FIGS. 6A, 6B, 6C, and 6D are cross sectional drawings illustrating twisted bundle configurations with different numbers of wires, in embodiments.

FIG. 7 is a cross section of a bundle-wound transformer solenoid-wound on a plastic spindle with a cast-in-place core formed of powdered magnetic material suspended in polymer, in embodiments.

FIG. 8 is a cross section of a bundle-wound transformer solenoid-wound with spindle removed and with a cast-in-place core formed of powdered magnetic material suspended in polymer, in embodiments.

FIG. 9 is a perspective illustration of the bundle-wound transformer of FIG. 8 with a mold remaining as a shell, in embodiments.

FIG. 10A is a cross section of a bundle-wound transformer having a rod or spindle of preformed magnetic material with cast-in-place magnetic material formed of powdered magnetic material suspended in polymer surrounding the coil, in embodiments.

FIG. 10B is a cross section of a bundle-wound transformer having a rod or spindle of preformed magnetic material with cast-in-place magnetic material formed of powdered magnetic material suspended in polymer surrounding the coil, the preformed rod or spindle of magnetic material being shorter than that of FIG. 10A to provide different magnetic properties than that of FIG. 10A, in embodiments.

FIG. 11 illustrates a hollow, perforated, toroidal spindle, in embodiments.

FIG. 12 illustrates a mold for casting preformed cores of powdered magnetic material suspended in polymer, in embodiments.

FIG. 13 illustrates a preformed core made using the mold of FIG. 12.

FIG. 14 is a flowchart of a method for forming a transformer, in embodiments.

### DETAILED DESCRIPTION

In an embodiment, a transformer uses bundles of multiple strands of wire that are pre-twisted together, each strand being insulated with a very high voltage dielectric polymer insulation which is typically a double layer polymer insulation with each layer having a minimum insulating layer thickness of 0.001″ (25 microns). This wire bundle is then wound on a cylindrical mandrel in a single layer to create a coil that is self-supporting. Selected ends of the coil are connected together to create two or more effective transformer windings. The coil is then potted into a slurry of activated ferrite powder mixed with silicone or epoxy or acrylic material. After curing the ferrite slurry effectively acts as a magnetic core.

There are numerous advantages to this type of transformer. The winding bundle, comprised of strands with very high dielectric rating, is suitable for the high voltage applications typical of high power transformers, or applications such as medical devices which require very high isolation between the input and output of the transformers. By selecting the number of strands and the wire gauge of each strand the designer can optimize the winding properties. Using many strands of fine gauge wire in parallel allows the engineer to achieve lower losses through the skin (Litz wire) effect. More strands also have the benefit of being able to generate more accurate turns ratios.

It is very simple and fast to twist the bundle of wires. It can be done in batches by hand using a drill or simple winding machine and it is also possible to purchase automated equipment to manufacture the twisted wire in a continuous fashion onto a reel. It is also simple to wind the twisted bundle to create the transformer winding using cylindrical mandrel attached to a winding machine. This process can also be automated. After winding the wire bundle will support itself so no support such as a bobbin is required.

The potting process is very fast and suitable for mass production. The winding can be potted into a cup or in a mold with no cup. In embodiments, vacuum impregnation may be used during the potting process to remove all voids and bubbles. The design engineer also can adjust the properties of the transformer core by using a variety of different magnetically activated powders alone or in combination with other powders and varying the mix ratio of powder to silicone/epoxy/acrylic, to achieve desired magnetic and physical properties.

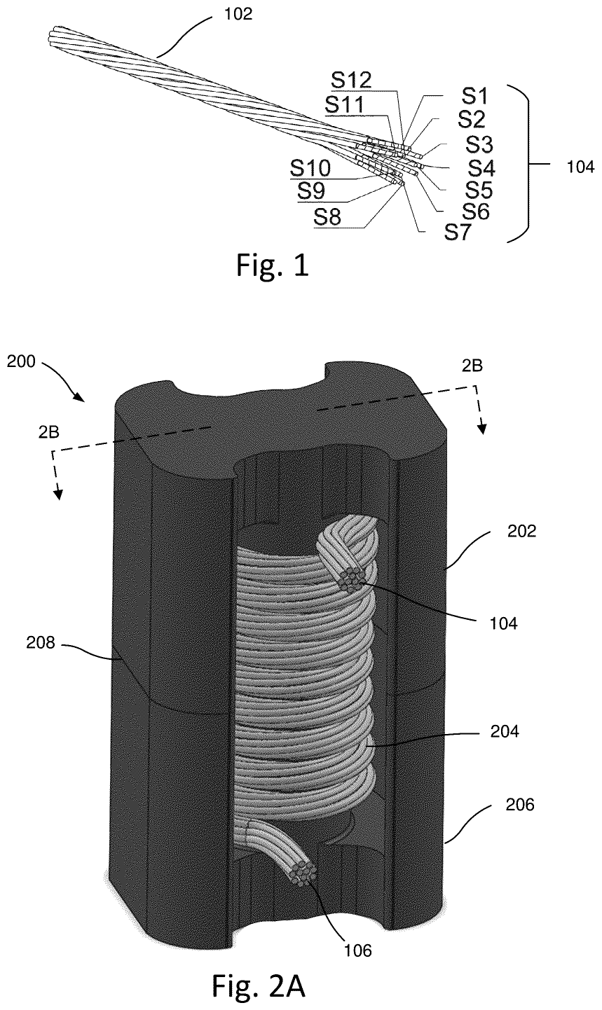

A group of individually insulated wires are twisted together, in embodiments without a bundle core as illustrated in FIG. 1, to form a twisted wire bundle. FIG. 1 illustrates a first twisted wire bundle end 104, the second twisted wire bundle end not shown in FIG. 1. In an embodiment, a twisted wire bundle may include 12 wires labeled S1-S12, although any number of wires may be used as explained below. The wires of the bundle 102 are each insulated with a thin plastic insulation, such as a Teflon, Kapton, or an equivalent plastic insulation. In some embodiments, the insulation is two or more layers of an extruded polymer at least one mil (0.001 inch or 25 microns) thick with a minimum breakdown voltage of 7 kV; in these embodiments the insulation is less than 0.012 inch (or less than 300 microns) thick. In some embodiments, two layers of insulation are used on each wire of the bundle. In particular embodiments, the insulation of wires of the bundle is color-coded so that wires S1-S12 of the bundle 102 can be easily identified and coupled together in desired configurations after a transformer is wound with the bundle; when using color-coded wires those wires intended to be coupled in parallel may have the same color or combination of colors while those intended to be coupled into separate windings or coupled in series may have different colors or combinations of colors.

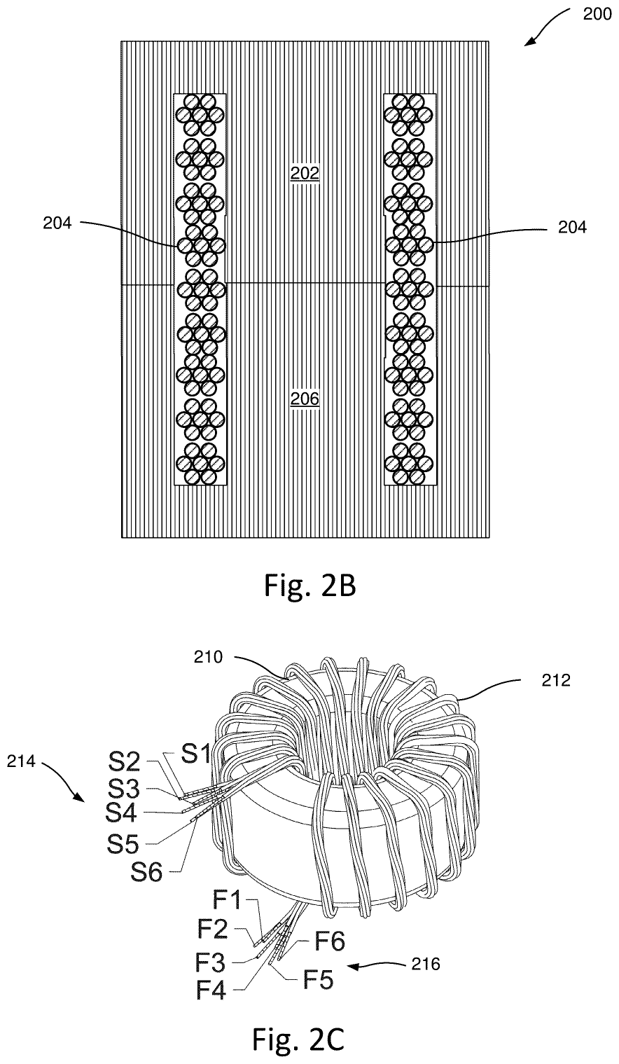

FIG. 2A is a perspective view of a bundle-wound transformer 200 with solenoid-wound coil using the twisted wire bundle 102 of FIG. 1. FIG. 2B is a cross section of the transformer of FIG. 2A. FIGS. 2A and 2B show a narrow E-E core, but other cores may be used, such as a preformed pot core or narrow E-I core. As shown in FIG. 2A, non-standard ferrite core 202, 206 with a very high aspect ratio winding window is shown with the twisted wire bundle 102. Both first end 104 and second end 106 of twisted wire bundle 102 are shown in FIG. 2A. Twisted wire bundle 102 is formed into a winding 204 that is placed over one core 202. Then the other core 206 is placed over the winding until the mating surfaces 208 touch and the assembly is secured with glue, tape and/or hardware. This type of core is uniquely suitable for the single layer wire bundle winding as it accommodates all the turns of the winding in a single layer without any unused space thereby reducing the overall volume of the transformer and increasing its power density. Aspect ratios between 6:1 and 20:1 would normally be used for the single layer bundle winding.

In embodiments, a toroid core 210 may be used, as illustrated in FIG. 2C. Toroid core 210 is wound with a wire bundle 212 in similar manner to form a transformer. In the embodiment of FIG. 2C, twisted wire bundle 212 includes six wires and has a first end 214 where the wires are labeled S1-S6 and a second end 216 where wires are labeled F1-F6. Any system of labels or color coding may be used to identify individual wires. Wires of the twisted wire bundle 212 are coupled in series, parallel, or series-parallel to form one or more windings as previously described.

In all embodiments illustrated, the wire bundle is twisted with at least one full 360 degree twist of the entire wire bundle for each turn of the winding. In embodiments, the twisted wire bundle is wound as a coil a single layer on a spindle or bobbin, which may or may not be removed before positioning the coil on a preformed core, such as an E-core, or casting a ferrite-resin core in and around the coil to form a core in place. In some embodiments with a preformed core, the core material is a ceramic comprising a nickel zinc or manganese zinc ferrite.

At the twisted wire bundle ends, such as first end 104 and second end 106 in FIG. 2A or first end 214 and second end 216 in FIG. 2C, wires or strands of the bundle are typically stripped of insulation for a short distance so they may be attached and electrically coupled to a header or electrically connected together.

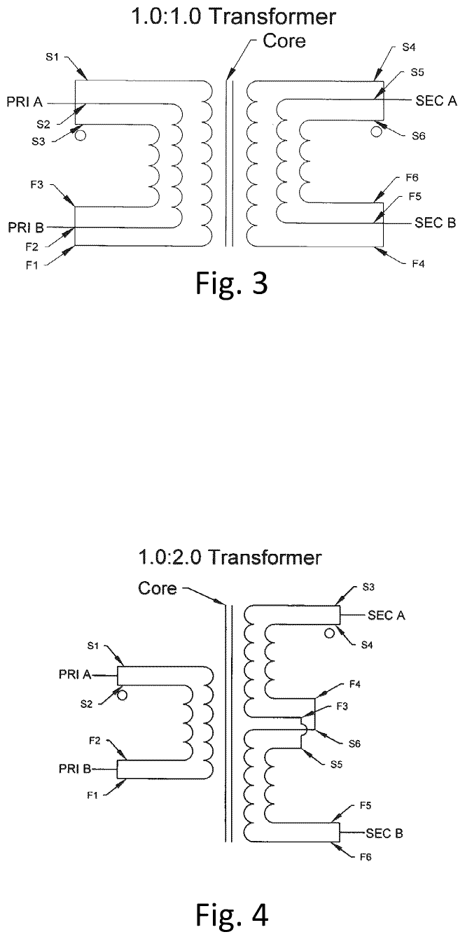

Wires or strands of the wire bundle can be coupled in a variety of ways to create transformers with a variety of turns ratios by coupling some strands in series, other strands in parallel, or other strands in series-parallel to form each of one or more windings as illustrated in the schematic diagrams of FIGS. 3, 4, 5A, 5B and 5C. For purposes of illustration, windings with 6 wires are shown. The labeling system for the wires is the same as that used in FIG. 2C, where the wires at first end 214 are labeled S1-S6 and the wires at second end 215 are labeled F1-F6.

FIG. 3 illustrates a 6-strand twisted wire bundle-wound transformer coupled as a 1:1 turns-ratio transformer. A first end of three wires are coupled at S1-S3 and the second end of the same wires are coupled at F1-F3 to form a primary winding. The remaining three wires are coupled at S4-S6 and F4-F6 to form a secondary winding.

FIG. 4 illustrates a 6-strand twisted wire bundle-wound transformer coupled as a 1:2 turns-ratio transformer. A first end of two wires are coupled at S1-S2 and the second end of the same wires are coupled at F1-F2 to form a primary winding. The remaining four wires are coupled as pairs in series to form a secondary winding. A first end of two wires are coupled at S3-S4. The second end of those wires, F3 and F4, are coupled to a first end of the remaining wires at S5 and S6, respectively. Then the second end of the remaining wires are coupled at F5-F6.

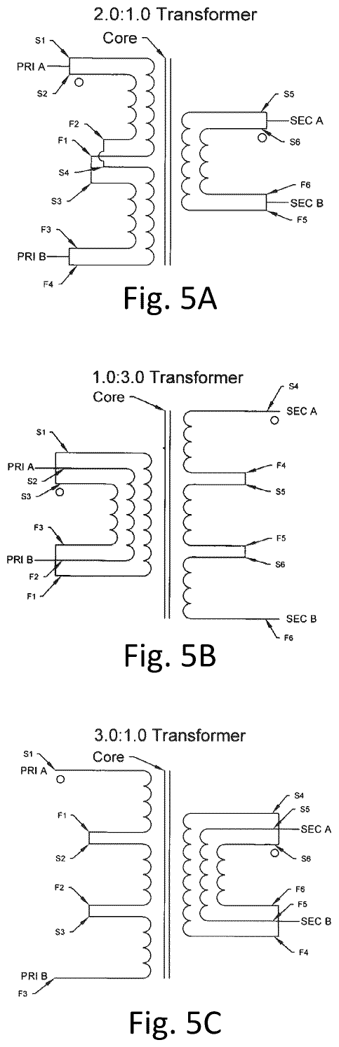

FIG. 5A illustrates 6-strand twisted wire bundle-wound transformer coupled as a 2:1 turns-ratio transformer. FIG. 5A may be understood as a reverse arrangement of the embodiment shown in FIG. 4, where 4 wires are coupled to form the primary winding and two wires are coupled to form the secondary winding. FIG. 5B illustrates a 6-strand twisted wire bundle-wound transformer coupled as a 1:3 turns ratio transformer. Three wires are coupled in parallel at S1-S3 and F1-F3 to form the primary winding. The other three wires are coupled in series to form the secondary winding. FIG. 5C illustrates a 6-strand twisted wire bundle-wound transformer coupled as a 3:1 turns ratio transformer. Three wires are coupled in series to form the primary winding. The other three wires are coupled in parallel to form the secondary winding.

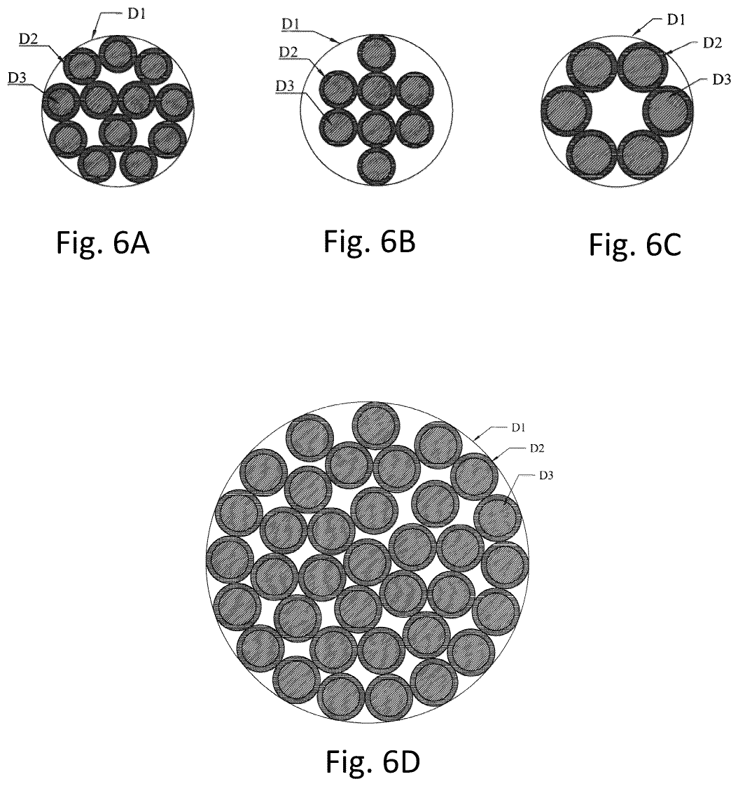

FIGS. 6A-6D illustrate twisted wire bundles with a variety of wire counts, any of which may be used in the embodiments disclosed herein. Representative embodiment of 12 wires (FIG. 6A), eight wires (FIG. 6B), six wires (FIG. 6C) and 36 wires (FIG. 6D), twisted wire bundles with any integer wire or strand count in the range 3 through at least 40 may be used. In all of the embodiments of FIGS. 6A-6D, reference character D3 indicates a wire and reference character D2 indicates the insulation of the wire. In some embodiments an optional jacket D1 surrounds the twisted wire bundle, in most embodiments each wire D3 of the bundle is insulated D2, but no jacket D1 surrounds the bundle

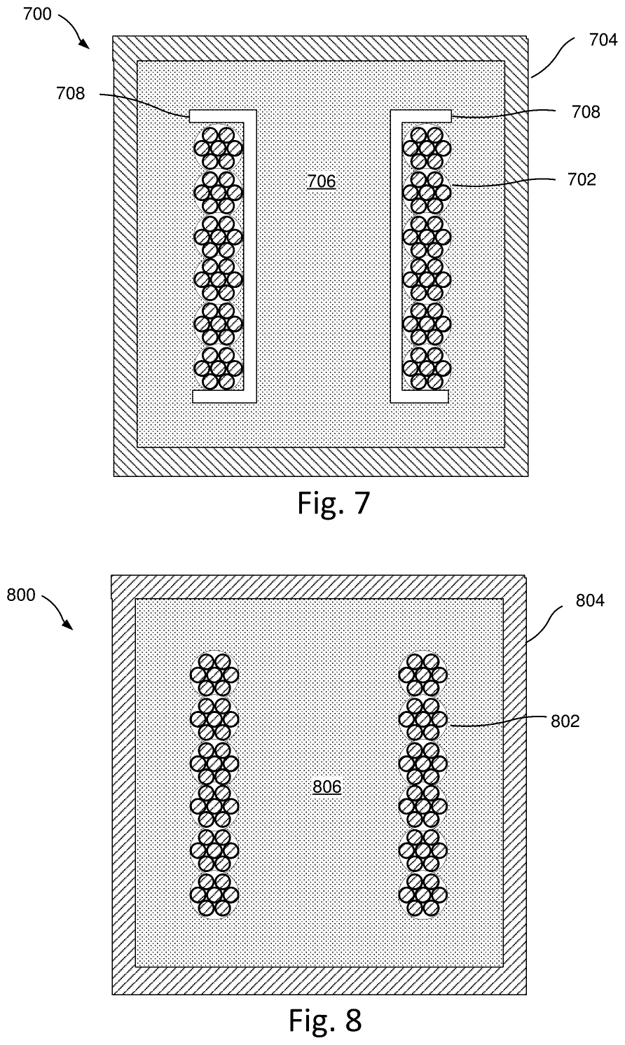

In alternative embodiments, as illustrated in FIGS. 7, 8, 9, 10A. 10B, and 11 a bundle-wound coil 702, 902, 1002, which may be solenoid wound or toroidal wound, is inserted into a plastic thin walled container. The container must be large enough to allow for clearance between the wire bundle and the container on at least 5 sides to allow a magnetic path to be created. A core material comprised of a powdered magnetic material suspended in a resin such as epoxy, acrylic, or silicone is then injected into the form and cured, thereby forming a magnetic core in place within the coil and the form.

In the embodiment illustrated in FIG. 7, the bundle-wound coil 702 is wound as a single-layer on a nonmagnetic plastic or ceramic spindle 808; the spindle with coil is inserted into the form 704 and the magnetic core 706 is formed in place in the form both within and without the coil, embedding the coil within the core.

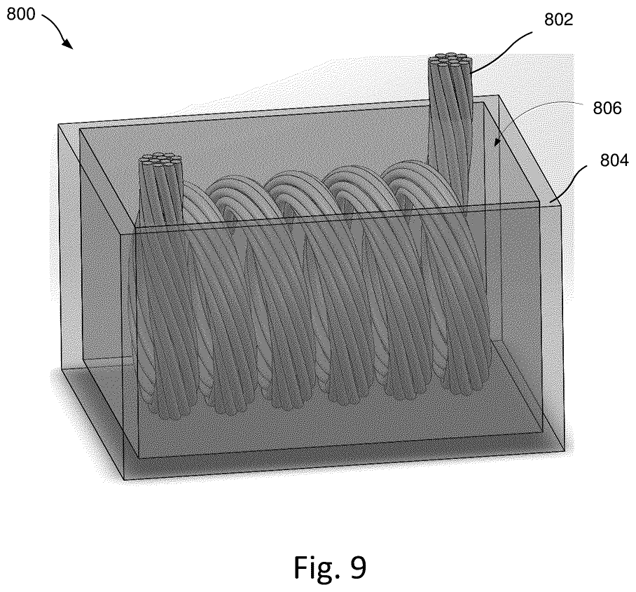

In the embodiment illustrated in FIG. 8 the bundle-wound transformer 800 has a coil 802 which was wound as a single-layer on a spindle; the spindle is removed from the coil and the coil is inserted into the form or mold 804 and the magnetic core 806 is formed in place in the form, incorporating core 806 both within and around coil 802. In this embodiment, the twisted bundle winding has an advantage over similar untwisted windings because the twisted wire bundle imparts mechanical support to prevent strands of the winding from being displaced as the magnetic material suspended in resin is injected into the form and then cured; in some embodiments the form or mold 804 is labeled and remains in place to serve as a permanent shell of the transformer 800. FIG. 9 illustrates bundle-wound transformer 800 in a perspective view with a translucent cast-in-place core of powdered magnetic material suspended in polymer and form or mold 804 remaining as a shell.

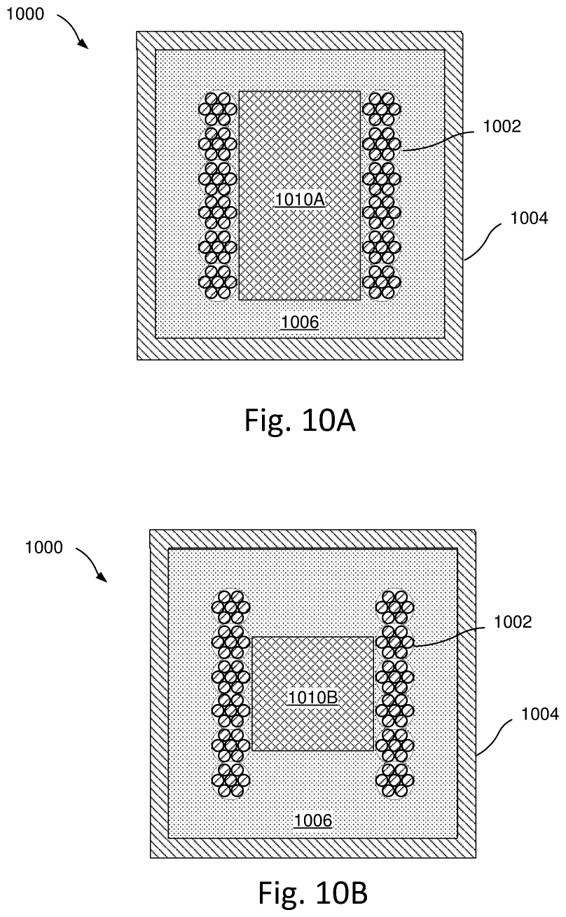

In the embodiments illustrated in FIG. 10A and FIG. 10B, the bundle-wound transformer 1000 has a coil 1002 is either wound as a single-layer of the bundle on a preformed rod or spindle of magnetic material such as a ferrite rod 1010A (FIG. 10A) or 1010B (FIG. 10B), serving as a partial core. Coil 1002 may also be wound on a nonmagnetic spindle with or without spindle removal and a ferrite rod 1010A or 1010B of preformed magnetic material added within the coil to serve as a partial core. The coil 1002 with partial core is then inserted into form 1004 and magnetic material 1006 suspended in resin is injected into the form 1004 to complete the magnetic core thereby completing magnetic paths between ends of the solenoid-wound winding and ends of ferrite rod 1010A or 1010B. The preformed magnetic material is of a size and type selected to provide desired magnetic properties and may be smaller in diameter or the same diameter as an inner diameter of the coil, and may be the same length as the coil (1010A), shorter than the coil (1010B). or longer than the length of the coil as necessary to provide the transformer with desired magnetic properties.

In a variation of the embodiments of FIGS. 10A-10B, the preformed rod or spindle may be a non-magnetic material such as Teflon or some other nonmagnetic and nonconductive plastic. When the magnetic material or resin is injected into the container and cured, the preformed rod of magnetic material would create a non-magnetic gap in the magnetic path equivalent to an air gap and the resulting transformer would have a higher saturation flux density. The length of the rod 1010A or 1010B may be adjusted to raise or lower the magnetizing inductance of the transformer and the saturation flux density thereby achieving properties of the transformer that may be desirable for various applications.

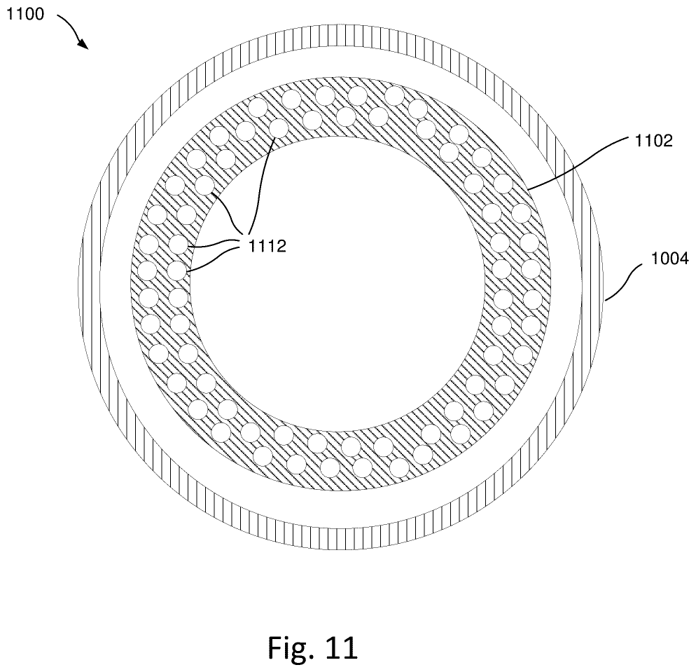

FIG. 11 illustrates a bundle-wound transformer 1100 with a hollow, perforated, toroidal spindle 1102 including perforations 1112 permitting flow of powdered magnetic material suspended in resin into and through the spindle when forming a magnetic core in place. In embodiments, perforations 1112 may be circular, oval, or formed as slots. When forming a toroidal transformer 1100 using spindle 1102 of FIG. 11, a twisted wire bundle (not shown) is wound on the toroidal spindle 1102 to form a coil, the spindle with coil is placed in a form 1104, and the powdered magnetic material suspended in resin is injected through the coil and perforations into the spindle to form a core within the toroidal spindle. In a particular embodiment, the powdered magnetic material suspended in resin is injected through a nozzle directly into one of the holes in the toroidal spindle.

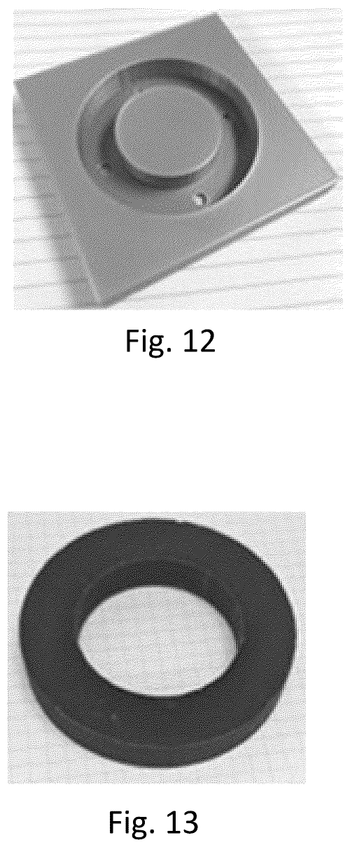

FIG. 12 illustrates a mold for casting preformed cores of powdered magnetic material suspended in polymer. In an alternative embodiment, pre-wound, bundle-wound, coils are placed in the mold and powdered magnetic material suspended in polymer is injected to form a toroidal transformer with a cast-in-place core. In embodiments, the cured polymer with suspended powdered magnetic material surrounds the coil except at bundle ends where wires of the bundle may be connected together to form windings of the transformer as shown in the embodiment of FIG. 9. FIG. 13 illustrates a preformed core made using the mold of FIG. 12.

In some embodiments, the resin used to suspend and bind the powdered magnetic material is an epoxy resin blended with a hardener so that the resin will cure after the resin with suspended powdered magnetic material is injected into the form. In alternative embodiments, the resin is a room-temperature or high-temperature curable silicone. On other alternative embodiments, the resin is an acrylic. In yet other embodiments the resin is a thermoplastic material that is heated, the powdered magnetic material is suspended in the hot resin, and the hot resin with suspended powdered magnetic material is injected into the coil and form before being allowed to cool and harden.

In the embodiments illustrated in FIGS. 7-11, in some embodiments the form remains as a permanent shell of the transformer and may bear part numbers, in other embodiments the form is removed after injecting the resin with suspended magnetic material and curing the resin to form the core; in these embodiments the cured resin with magnetic material may be marked directly with part numbers and serve as its own shell.

In some embodiments, not shown, such as a variation of FIG. 7 or 11, the resin with suspended magnetic material is injected into the bundle-wound coil through a nozzle inserted into the center of the spindle of FIG. 7 or through a pore into the perforated toroidal spindle of FIG. 11.

In alternative embodiments of the embodiments illustrated in FIGS. 7-11, the coil is mechanically coupled to a header (Not shown in figures) to add stability during injection of resin with suspended powdered magnetic material.

It is anticipated that the embodiments of FIGS. 7-11 may be wound with any of the bundles discussed with reference to FIGS. 1 and 6A-6D, and wires of the bundle coupled as discussed with reference to FIGS. 3, 4, 5A, 5B and 5C.

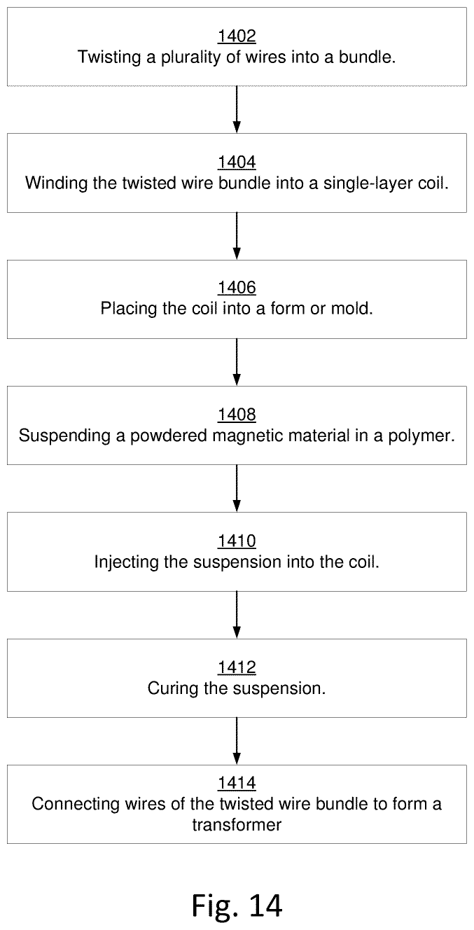

FIG. 14 is a flowchart of a method 1400 for forming a transformer as disclosed herein. Method 1400 includes steps 1402-1414.

Step 1402 includes twisting a plurality of wires into a twisted wire bundle. In an example of step 1402, the twisted wire bundle may include different numbers of strands, as shown in FIGS. 1 and 6A-6D, for example.

Step 1404 includes winding the twisted wire bundle into a single-layer coil.

Step 1406 includes placing the single-layer coil into a form or mold. In an example of step 1406, the form may include any of the forms shown in FIGS. 8-11, or alternatives as discussed herein.

Step 1408 includes suspending powdered magnetic material in a polymer. In an example of step 1408, the powdered magnetic material may be activated ferrite powder and the polymer may be silicone, epoxy or an acrylic material, for example.

Step 1410 includes injecting the suspension into the coil. In an example of step 1410, the polymer with suspended magnetic material is injected into the form containing the single-layer coil.

Step 1412 includes curing, or hardening, the polymer with suspended magnetic material.

Step 1414 includes connecting wires of the twisted wire bundle to form transformer windings. In an example of step 1414, wires may be connected in any of the configurations shown in FIGS. 3, 4, 5A, 5B or 5C, for example.

The transformer manufactured as disclosed herein is uniquely suited to high frequency applications from 500 kHz to 20 MHz. The single layer winding greatly reduces winding capacitance and increases the self-resonant frequency, both important benefits for high frequency transformers. The leakage inductance between the primary and the secondary(s) windings is exceptionally low compared to conventional transformers and this is also beneficial to high frequency operation. The ferrite and silicone/epoxy core may have lower permeability than conventionally fired cores manufactured with the same material and this is advantageous for high frequency operation. The use of multiple strands of fine gauge wire twisted together will result in a low AC winding loss at high frequency due to the skin/Litz wire effect.

Another benefit of this type of transformer is that higher power densities can be achieved compared to conventional wire wound transformers. All of the heat generated by the winding and core is transferred by conduction because the potting process eliminates all the air voids in the core and between the core and the winding. Conductive heat transfer is much more effective than convective heat transfer and greatly reduces the hot spots that are normal for conventional wire wound transformers.

The winding bundle, or twisted-wire bundle, contains 4 or more strands of round copper wire, each with a flexible thin wall layer of flexible insulation. The layer of insulation may be extruded Teflon, polyamide, polyester or silicone, for example. To achieve a high dielectric rating for the insulation it is normally applied in two or three layers, each layer between 0.015″ and 0.003″ thick. When twisting the bundle, it should be twisted to have at least one and not more than 3 twists within the length of a single turn of the coil after it is wound. The diameter and turn count of the winding is determined by conventional methods to ensure the core flux density is below saturation and with an acceptable amount of losses.

With all of the windings including both the primary and one or more secondary windings being contained in a single wire bundle, the leakage inductance from primary to secondary is far lower than a conventional winding in which the primary and secondary winding(s) are typically wound separately. Lower leakage inductance is beneficial in high frequency transformers and is also essential for some unique applications such as a pulse transformer or a flyback transformer.

The core material can be any type of the major classes of magnetic powder cores. As disclosed herein for a high frequency transformer it may be a nickel zinc, or a low permeability manganese zinc activated powder or a ferrite powder containing nickel zinc or manganese zinc, for example.

In an embodiment, half of the strands of the winding bundle are connected at the lead ends to create one conductor, and the other half of the strands are connected to create a second conductor. In this manifestation a transformer with a one to one turns ratio is created.

In another embodiment, strands of one winding are connected in parallel while another winding is created by connecting one or more strands in series to create a winding with 2X, 3X, or 4X turns to create a 2:1, 3:1, or 4:1 turns ratio which may be used in a step up or step down configuration to increase or decrease the voltage from the primary input to the secondary output of the transformer.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A transformer comprising:
a twisted-wire bundle comprising a plurality of wires extending from a first bundle end to a second bundle end, the twisted-wire bundle wound into a coil with a single layer of the twisted-wire bundle;
the plurality of wires of the twisted-wire bundle comprising wires insulated with extruded plastic insulation at least one thousandth of an inch thick;
a magnetic material disposed within the transformer, the magnetic material including at least a portion within the coil; and
the coil having either solenoid or toroid shape.

2. The transformer of claim 1 wherein the magnetic material comprises at least some magnetic material comprising powdered magnetic material suspended in a resin and cured in place within the transformer.

3. The transformer of claim 2 wherein the coil has solenoid shape.

4. The transformer of claim 3 wherein the magnetic material further comprises a rod or spindle of a ferrite within the coil, the coil surrounded by least some magnetic material comprising powdered magnetic material suspended in a resin and cured in place in the transformer.

5. The transformer of claim 2 wherein the coil surrounds a toroidal spindle, the toroidal spindle having perforations that allow flow into the toroidal spindle of the at least some magnetic material comprising powdered magnetic material suspended in a resin and cured in place in the transformer.

6. The transformer of claim 2, further comprising a form surrounding the coil and the at least some magnetic material comprising powdered magnetic material suspended in a resin and cured in place in the transformer.

7. The transformer of claim 1 wherein the extruded plastic insulation comprises at least two layers of insulation each at least 0.001 inch thick on each wire of the twisted-wire bundle.

8. The transformer of claim 1 wherein the extruded plastic insulation comprises Teflon.

9. The transformer of claim 7 wherein the extruded plastic insulation is less than 0.012 inch thick.

10. The transformer of claim 1 wherein the extruded plastic insulation is color-coded to permit identification of wires of the twisted-wire bundle.

11. The transformer of claim 1 wherein the twisted-wire bundle comprises between 3 and 40 wires.

12. The transformer of claim 10 where the magnetic material comprises nickel zinc or manganese zinc ferrite.

13. The transformer of claim 3, further comprising a form surrounding the coil and the at least some magnetic material comprising powdered magnetic material suspended in a resin and cured in place in the transformer.

14. The transformer of claim 4, further comprising a form surrounding the coil and the at least some magnetic material comprising powdered magnetic material suspended in a resin and cured in place in the transformer.

15. The transformer of claim 5, further comprising a form surrounding the coil and the at least some magnetic material comprising powdered magnetic material suspended in a resin and cured in place in the transformer.

16. The transformer of claim 9, further comprising a form surrounding the coil and the at least some magnetic material comprising powdered magnetic material suspended in a resin and cured in place in the transformer.

17. A method of forming a transformer comprising:
twisting a plurality of wires into a twisted wire bundle;
winding the twisted wire bundle into a single-layer coil;
placing the single-layer coil into a form;
suspending powdered magnetic material in a polymer;
injecting the polymer with suspended magnetic material into the single-layer coil;
curing, or hardening, the polymer with suspended magnetic material; and
connecting wires of the twisted wire bundle to form transformer windings.

18. The method of claim 17, further wherein the form comprises a magnetic material or further comprising inserting a magnetic rod into the single-layer coil.

19. The method of claim 18, wherein the polymer is selected from a silicone and an epoxy.

20. The method of claim 18 where each wire of the plurality of wires is insulated with extruded plastic insulation between 0.001 and 0.012 inch thick.
